(19) United States
(12) Patent Application Publication
(10) Pub. No.: US 2014/0126818 A1
(43) Pub. Date: May 8, 2014

(54) METHOD OF OCCLUSION-BASED BACKGROUND MOTION ESTIMATION

(71) Applicant: SONY CORPORATION, Tokyo (JP)

(72) Inventor: Jianing Wei, San Jose, CA (US)

(73) Assignee: SONY CORPORATION, Tokyo (JP)

(21) Appl. No.: 13/670,296

(22) Filed: Nov. 6, 2012

(51) Int. Cl. G06K 9/34

(52) U.S. Cl. CPC G06K 9/34
USPC 382/171; 382/173

(57) ABSTRACT

A technique for estimating background motion in monocular video sequences is described herein. The technique is based on occlusion information contained in video sequences. Two algorithms are described for estimating background motion: one fits well for general cases, and the other fits well for a case when available memory is very limited. The significance of the technique includes: a motion segmentation algorithm with adaptive and temporally stable estimate of the number of objects is developed, two algorithms are developed to infer occlusion relations among segmented objects using the detected occlusions and background motion estimation from the inferred occlusion relations.

### FIELD OF THE INVENTION

The present invention relates to the field of image processing. More specifically, the present invention relates to motion estimation.

### BACKGROUND OF THE INVENTION

Motion estimation is the process of determining motion vectors that describe the transformation from one image to another, usually from adjacent frames in a video sequence. The motion vectors may relate to the whole image (global motion estimation) or specific parts, such as rectangular blocks, arbitrary shaped patches or even per pixel. The motion vectors may be represented by a translational model or many other models that are able to approximate the motion of a real video camera, such as rotation and translation in all three dimensions and zoom.

Applying the motion vectors to an image to synthesize the transformation to the next image is called motion compensation. The combination of motion estimation and motion compensation is a key part of video compression as used by MPEG 1, 2 and 4 as well as many other video codecs.

### SUMMARY OF THE INVENTION

A technique for estimating background motion in monocular video sequences is described herein. The technique is based on occlusion information contained in video sequences. Two algorithms are described for estimating background motion: one fits well for general cases, and the other fits well for a case when available memory is very limited. The significance of the technique includes: a motion segmentation algorithm with adaptive and temporally stable estimate of the number of objects is developed, two algorithms are developed to infer occlusion relations among segmented objects using the detected occlusions and background motion estimation from the inferred occlusion relations.

In one aspect, a method of motion estimation programmed in a memory of a device comprises performing motion segmentation to segment an image into different objects using motion vectors to obtain a segmentation result, generating an occlusion matrix using the segmentation result, occluded pixel information and image data and estimating background motion using the occlusion matrix. The occlusion matrix is of size K×K, wherein K is a number of objects in the image. Each entry in the occlusion matrix represents the number of pixels one segment occludes another segment. Estimating the motion of the background object includes finding the background object. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.

In another aspect, a method of motion segmentation programmed in a memory of a device comprises generating a histogram using input motion vectors, performing K-means clustering with a different number of clusters and generating a cost, determining a number of clusters using the cost, computing a centroid of each cluster and clustering a motion vector at each pixel with a nearest centroid, wherein the clustered motion vector and nearest centroid segments a frame into object. A number of the segments is not fixed. A temporally stable estimation of the number of clusters is developed. A Bayesian approach for estimation is used. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.

In another aspect, a method of occlusion relation inference programmed in a memory of a device comprises finding a first corresponding motion segment of an occluding object, finding a pixel location in the next frame, finding a second corresponding motion segment of the occluded object, incrementing an entry in an occlusion matrix and repeating the steps until all occlusion pixels have been traversed. The entry represents the number of pixels a first segment occludes a second segment. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.

In another aspect, a method of occlusion relation inference programmed in a memory of a device comprises using a sliding window to locate occlusion regions and neighboring regions, moving the window if there are no occluded pixels in the window, computing a first luminance histogram at the occluded pixels, computing a second luminance histogram for each motion segment inside the window, comparing the first luminance histogram and the second luminance histogram, identifying a first motion segment with a closest luminance histogram to an occlusion region as a background object in the window, identifying a second motion segment with the most pixels among all but background motion segments as an occluding, foreground object, incrementing an entry in an occlusion matrix by the number of pixels in the occlusion region in the window and repeating the steps until an entire frame has been traversed. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.

In another aspect, a method of background motion estimation programmed in a memory of a device comprises designing a metric to measure an amount of contradiction when selecting a motion segment as a background object, assigning a background motion to be the motion segment with a minimum amount of contradiction and subtracting the background motion of the background object from motion vectors to obtain a depth map. The method further comprises determining if the number of occluded pixels is below a first threshold or a minimum contradiction is above a second threshold, or determining if a total number of occlusion pixels is below a third threshold, then assigning the background object to be a largest segment, and a corresponding motion is assigned to be the background motion. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.

In another aspect, an apparatus comprises a video acquisition component for acquiring a video, a memory for storing an application, the application for: performing motion segmentation to segment an image of the video into different objects using motion vectors to obtain a segmentation result, generating an occlusion matrix using the segmentation result, occluded pixel information and image data and estimating background motion using the occlusion matrix and a processing component coupled to the memory, the processing component configured for processing the application. The occlusion matrix is of size K×K, wherein K is a number of objects in the image. Each entry in the occlusion matrix represents the number of pixels one segment occludes another segment. Estimating the background motion includes finding the background object.

### BRIEF DESCRIPTION OF THE DRAWINGS

FIG. 1 illustrates an exemplary case where background motion is different from global motion according to some embodiments.

FIG. 2 illustrates a block diagram of a method of occlusion-based background motion estimation according to some embodiments.

FIG. 3 illustrates a block diagram of a method of adaptive K-means clustering motion segmentation according to some embodiments.

FIG. 4 illustrates a diagram of occlusion between two objects according to some embodiments.

FIG. 5 illustrates a flowchart of a method of occlusion relation inference according to some embodiments.

FIG. 6 illustrates a flowchart of a method of low memory usage occlusion inference according to some embodiments.

FIG. 7 illustrates a diagram of an estimated depth map using background motion estimation.

FIG. 8 illustrates a block diagram of an exemplary computing device configured to implement the occlusion-based background motion estimation method according to some embodiments.

### DETAILED DESCRIPTION OF THE PREFERRED EMBODIMENT

A technique for estimating background motion in monocular video sequences is described herein. The technique is based on occlusion information contained in video sequences. Two algorithms are described for estimating background motion: one fits well for general cases, and the other fits well for a case when available memory is very limited. The second algorithm is tailored toward platforms where memory usage is heavily constrained, so low cost implementation of background motion estimation is made possible.

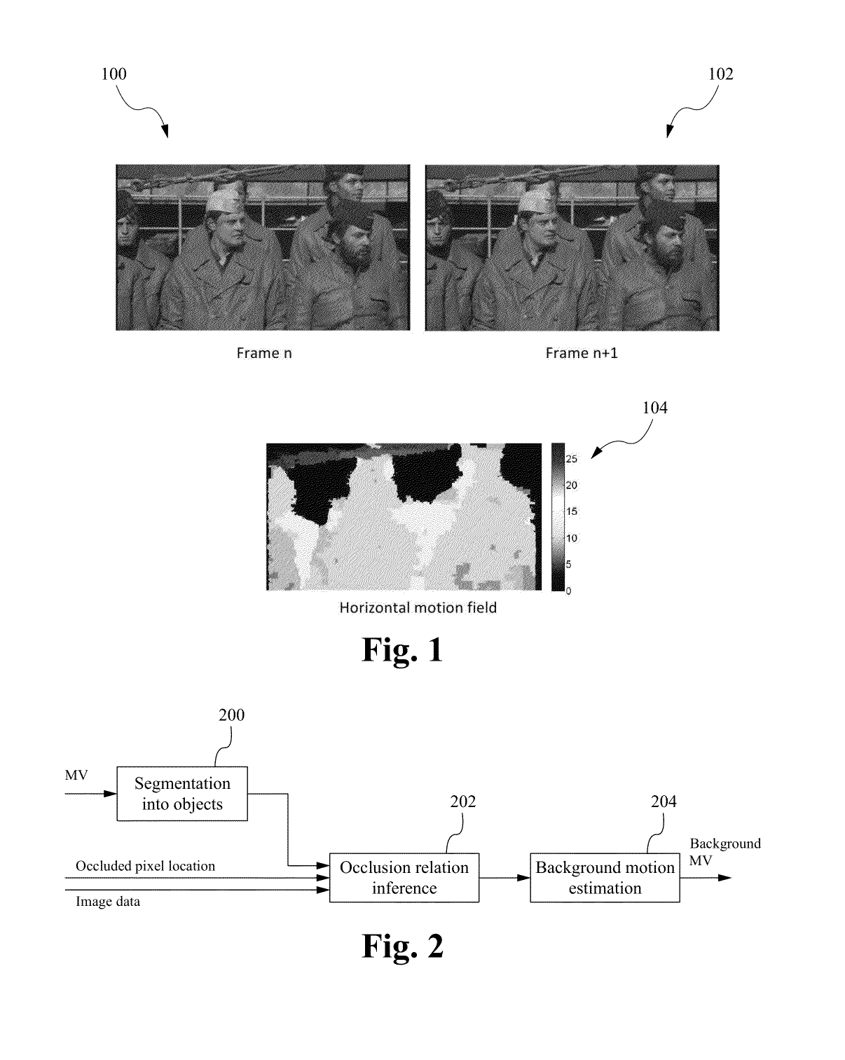

Background motion estimation is very important in many applications, such as depth map generation, moving object detection, background subtraction, video surveillance, and other applications. For example, a popular method to generate depth maps for monocular video is to compute motion vectors and subtract background motion from the motion vectors. The remaining magnitude of motion vectors will be the depth. Often times, people use global motion instead of background motion to accomplish tasks. Global motion accounts for the motion of the majority of pixels in the image. In cases where background pixels are less than foreground pixels, global motion is not equal to background motion. FIG. 1 illustrates a case where background motion is different from global motion. Image 100 shows the image at frame n. Image 102 shows the image at frame n+1. Image 104 shows a horizontal motion field. In this case, the foreground soldiers occupy the majority of the image. So the global motion is the motion of the soldiers. But the background motion is the motion of the background structure, which is zero motion. In such situations, motion estimated from registration between two images using affine models are global motion, instead of background motion. Using global motion to replace background motion can lead to poor results. Two algorithms are described herein to estimate the background motion. One algorithm fits for general situations. The other algorithm fits for the case where memory usage is heavily constrained. Therefore, the second algorithm is able to be implemented on low cost platforms and products. Both algorithms use occlusion information contained in video sequences. The occlusion region or occluded pixel locations are able to be either computed using available algorithms or obtained from estimated motion vectors in compressed video sequences. The algorithms described herein will utilize results of occlusion detection and motion estimation.

### Occlusion-Based Background Motion Estimation

Occlusion is one of the most straightforward cues to infer relative depth between objects. If object A is occluded by object B, then object A is behind object B. Then, background motion is able to be estimated from the relative occlusion relations among objects. So the primary problem becomes how does one know which object occludes which object. In video sequences, it is possible to detect occlusion regions. Occlusion regions refer to either covered regions, which appear in the current frame but will disappear in the next frame due to occlusion of relatively closer objects, or uncovered regions, which appeared in the previous frame but disappear in the current frame due to the movement of occluding objects. Occlusion regions, both covered and uncovered, should belong to occluded objects. If occlusion regions are able to be associated with certain objects, then the occluded objects are able to be found. So the frame is segmented into different objects. Then, given the covered and uncovered pixel locations, algorithms are developed to infer occlusion relations among objects. Finally, from the estimated occlusion relations, the background motion is estimated. FIG. 2 shows the block diagram of the system according to some embodiments. In the diagram, motion vectors are input to the segmentation block 200. Motion segmentation is performed to segment the image into different objects. The segmentation result along with detected occluded pixels and image data are input to occlusion relation inference block 202. The result or output of occlusion relation inference will be occlusion matrix O of size K×K, where K is the number of objects in the image. Entry (i, j) of the occlusion matrix O is the number of pixels object i occludes object j. Then, the occlusion matrix is input to background motion estimation block 204 in order to estimate the correct background object, and therefore the correct background motion.

### Motion Segmentation

There are various methods to segment the image into different objects or segments based on motion vectors. In order to achieve fast computation and reduce memory usage, K-means clustering for motion segmentation is used. The K-means clustering algorithm is a technique for cluster analysis which partitions n observations into a fixed number of clusters K, so that each observation vⱼ belongs to the cluster with the nearest centroid cᵢ. K-means clustering works by minimizing the following cost function:

$${Φ}_{k} = {\sum }_{i = 1}^{k} {\sum }_{j ∈ S}^{ } {‖ {v}_{j} - {c}_{i} ‖}^{2} . \qquad ( 1 )$$

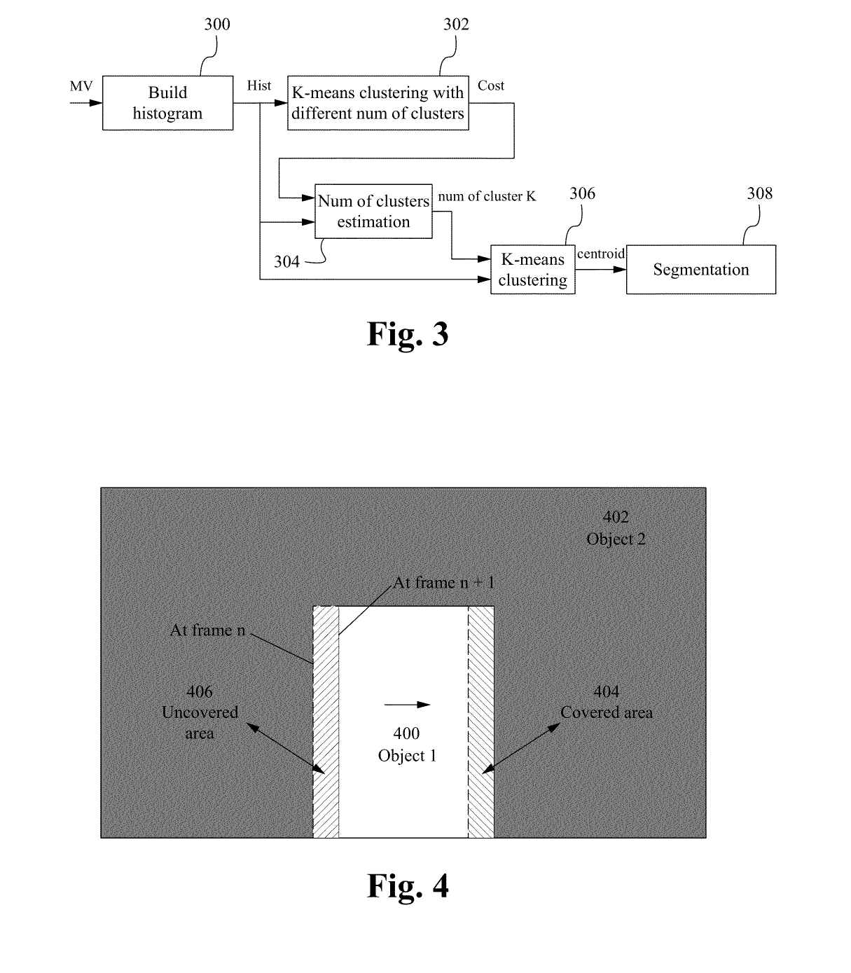

The K-means clustering algorithm is used to do the motion segmentation. However, some modifications have been made. First, the number of clusters/segments K is not fixed. An algorithm is used to estimate the number of segments in order to make it adaptive. In addition, in order to avoid large variation in segmentation results between consecutive frames, a temporal stabilization mechanism is used. Once the number of segments/clusters is determined, K-means clustering is used to find out the centroid of these clusters or segments. Then, the motion vector at each pixel is clustered to the nearest centroid in Euclidian distance to complete the motion segmentation. FIG. 3 shows the block diagram of a motion segmentation algorithm according to some embodiments. FIG. 3 describes the “segmentation into objects” block in FIG. 2. Motion vectors are input to the build histogram block 300. A histogram is generated and sent to the K-means clustering block 302, the number of clusters estimation block 304 and K-means clustering block 306. The K-means clustering block 302 performs K-means clustering with a different number of clusters and sends the cost to the number of clusters estimation block 304. The number of clusters estimation block 304 determines the number of clusters K and sends the result to the K-means clustering block 306. The K-means clustering block 306 computes a centroid of a cluster which is sent to the segmentation block 308.

### Stable Estimation of Number of Clusters

In order to make the estimate of number of clusters temporally stabilized, a Bayesian approach for estimation is used, with the prior probability obtained from the prediction based on the posterior probability in previous frames. The Bayesian approach computes the maximum a posteriori estimate of the number of clusters. The posterior probability of the number of clusters kₙ in the current frame given the observations (motion vectors) in the current frame and all previous frames z_{1,2 . . . , n} are able to be computed as:

$$P ( {K}_{n} \vert {z}_{1 \text{:} n} ) = \frac{P ( {z}_{n} \vert {k}_{n} ) P ( {k}_{n} \vert {z}_{1 \text{:} n - 1} )}{P ( {z}_{n} \vert {z}_{1 \text{:} n - 1} )} . \qquad ( 2 )$$

The estimate of the number of clusters is the value kₙ, which maximizes P(kₙ|z_{1:n}). The denominator P(Zₙ|Z_{1:n-1}) is constant for all values of kₙ. So maximizing P(kₙ|z_{1:n}) is equivalent to maximizing the numerator. The conditional probability P(zₙ|kₙ) is able to be modeled as a decreasing function of a cost function Ψ(zₙ, kₙ):

$$\begin{matrix} P ( {z}_{n} \vert {k}_{n} ) = 1 - Ψ ( {z}_{n} , {k}_{n} ) \\ = 1 - ( \text{?} + λ {k}_{n} )\end{matrix} \\ \text{?} \text{indicates text missing or illegible when filed} \qquad ( 3 )$$

where Φₖ is the K-means clustering cost function and is a function of the number of clusters kₙ and the observations (motion vectors) zₙ of the current frame n. The cost function Ψ(zₙ,kₙ) tries to balance the number of clusters and the cost due to clustering. More clusters will result in smaller cost because of finer partition of the observations. But too many clusters may not help. So the combination of cost and number of clusters weighted by λ determines the final cost function. Smaller cost means higher probability. The conditional probability is constructed so that it is a decreasing function of the cost function. The second term P(kₙ|z_{1:n-1}) is able to be computed as:

$$P ( {k}_{n} \vert {z}_{1 \text{:} n - 1} ) = \text{?} P ( {k}_{n} \vert {k}_{n - 1} ) P ( {k}_{n - 1} \vert {z}_{1 \text{:} n - 1} ) , \\ \text{?} \text{indicates text missing or illegible when filed} \qquad ( 4 )$$

where P(kₙ|kₙ₋₁) is the state transition probability, and P(kₙ₋₁|z_{1:n-1}) is the posterior probability computed from the previous frame. The state transition probability is able to be predefined. A simple form is used to speed up computation:

P(kₙ|kₙ₋₁)=2^{-|k}^{ₙ}^{-k}^{_{n−1}}^{|}. (5)

With the posterior probability computed as in Equation (2), the number of clusters is estimated as the number kₙ which has the maximum posterior probability, e.g.:

$${K}_{optimal} = arg {max}_{\text{?}} P ( {k}_{n} \vert {z}_{1 \text{:} n} ) . \\ \text{?} \text{indicates text missing or illegible when filed} \qquad$$

### Motion Segmentation

After the number of clusters or segments has been estimated, a K-means clustering technique is used to cluster the motion vectors at each pixel. The centroid of each cluster will be computed, and the motion vector at each pixel is able to be clustered with the closest centroid. Then, motion segmentation is achieved. The entire frame is segmented into K objects.

### Occlusion Relation Inference

From available occlusion detection results, it is able to be determined which pixels in the current frame will be covered in the next frame and which pixels in the current frame are uncovered in the previous frame. The known fact is that the occlusion pixels belong to occluded objects. FIG. 4 shows an illustration of one object occluding another object. In this example, object 1 400 moves to the right and is occluding the background object 2 402. Both the covered area 404 at frame n and the uncovered area 406 at frame n+1 belong to object 2 402. So if the occlusion pixels are able to be associated with a certain motion segment, then it will help the determination of background object, and thus the background motion. The difficulty lies in the fact that the estimated motion vectors at the occluded pixels are not able to be trusted, because if a pixel disappears in the previous or next frame, then the motion at this pixel estimated from matching between consecutive frames becomes unreliable. Two algorithms have been developed to associate the occluded pixels with motion segments, one fits for general purposes, and the other fits low cost implementation where only limited memory is available or no frame memory is able to be used. The occlusion relation is able to be inferred after occluded pixels are associated with corresponding motion segments. The output of occlusion relation inference is an occlusion matrix O, with entry O_{(i,j)} representing the number of pixels segment i occludes segment j. The total sum of the entries in matrix O is equal to the total number of occluded pixels.

### General Purpose Occlusion Inference Algorithm

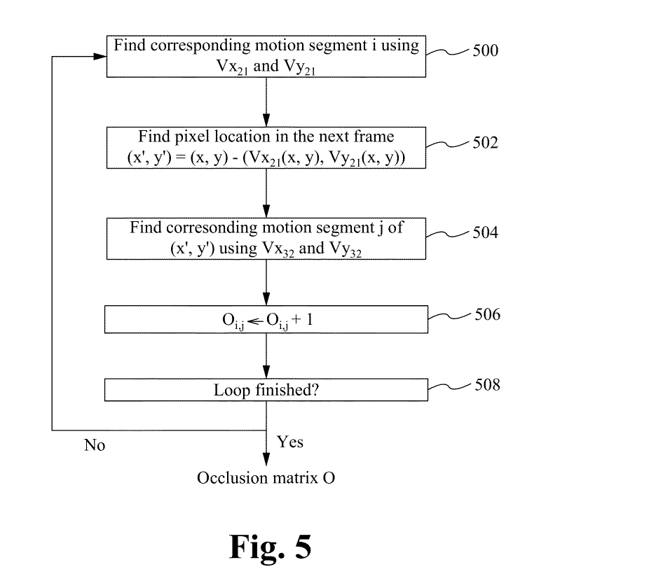

To simplify notation, Vx₁₂ and Vy₁₂ are used to denote the horizontal and vertical motion vector from frame n−1 to frame n, and Vx₂₁ and Vy₂₁ are used to denote the horizontal and vertical motion vector from frame n to frame n−1. Vx₂₃ and Vy₂₃ are used to denote horizontal and vertical motion vector from frame n to frame n+1, and use Vx₃₂ and Vy₃₂ to denote the horizontal and vertical motion vector from frame n+1 to frame n. If a pixel (x,y) on frame n is identified as a covered pixel, then Vx21(x,y) and Vy21(x,y) is used to cluster (x,y) into one of the motion segments i, and this segment i is identified as the occluded object. In addition, the pixel (x′,y′)=(x,y)−(Vx₂₁(x,y), Vy₂₁(x,y)) on frame n+1 is analyzed. Motion vector Vx₃₂(x′,y′) and Vy₃₂(x′,y′) will be used to cluster into one of the motion clusters j, and this segment j is identified as the occluding object. Entry (i,j) in the occlusion matrix O is then incremented by 1. All of occlusion pixels are traversed in order to obtain the final occlusion matrix O. The algorithm description is shown in FIG. 5.

In the step 500, a corresponding motion segment i using Vx₂₁ and Vy₂₁ is found. In the step 502, a pixel location in the next frame (x′,y′)=(x,y)−(Vx₂₁(x,y), Vy₂₁(x,y)) is found. In the step 504, a corresponding motion segment j of (x′, y′) using Vx₃₂ and Vy₃₂ is found. In the step 506, entry (i,j) in the occlusion matrix O is incremented by 1. In the step 508, it is determined if all occlusion pixels (x, y) have been traversed. If all occlusion pixels (x, y) have been traversed, then the occlusion matrix O is completed. If all occlusion pixels (x, y) have not been traversed, then the process returns to the step 500. In some embodiments, the order of the steps is modified. In some embodiments, more or fewer steps are implemented.

### Low Memory Usage Occlusion Inference Algorithm

The algorithm described in the section above uses motion vectors to associate occlusion pixels to motion segments. Both forward and background motion vectors between three consecutive frames are able to be stored. That is a total of eight frames of motion vectors. In cases where memory is limited and very expensive to use, the previous algorithm may not be appropriate. In this section, an algorithm that uses a small amount of memory is described. The primary reason for the need to store many frames of motion vectors is that the motion in occluded pixels cannot be trusted. So motion from adjacent frames needs to be used as a substitute. However, instead of using motion to associate occluded pixels with motion segments, appearance is able to be used to associate occluded pixels with motion segments. It is assumed that the occluded region belongs to the segment with the most similar appearance. Appearance usually refers to luminance, color, and texture properties. But in order to make the algorithm cost effective, only the luminance property is used herein, although color and texture properties are able to also be used to provide better performance. A luminance histogram is used to find similarity between regions. Sliding windows are used to locate occlusion regions and their neighboring regions. A multi-scale sliding window is used to traverse the image. In order to save memory and computation, the multiple scales are only on the width of the window. In other words, the height of the window is fixed, and only the width is varied to account for different scales. So only a fixed number of lines need to be stored instead of the whole frame. When the sliding the window goes across the image, if there are no occluded pixels inside the window, then the window is moved to the next position. Otherwise, the luminance histogram at the occluded pixels is computed. For other pixels inside the window, pixels belonging to the same motion segment are put together, and a luminance histogram for each motion segment inside the window is constructed. The luminance histogram of the occlusion region and the luminance histograms of the motion segments are compared. The motion segment i with the closest luminance histogram to the occlusion region is identified as the background object in that window. The motion segment j with the most pixels among all but background motion segments is identified as the occluding/foreground object. Then entry (i,j) in occlusion matrix O is incremented by the number of pixels in the occlusion region inside the sliding window. Some criteria are able to be used to remove outliers, for example, the number of occluding pixels and occluded pixels in a sliding window has to be over a certain threshold, and the level of similarity between histograms has to be over a certain value. After multi-scale sliding windows traverse across the entire frame, the final occlusion matrix O is obtained to infer the occlusion relations among motion segments or objects.

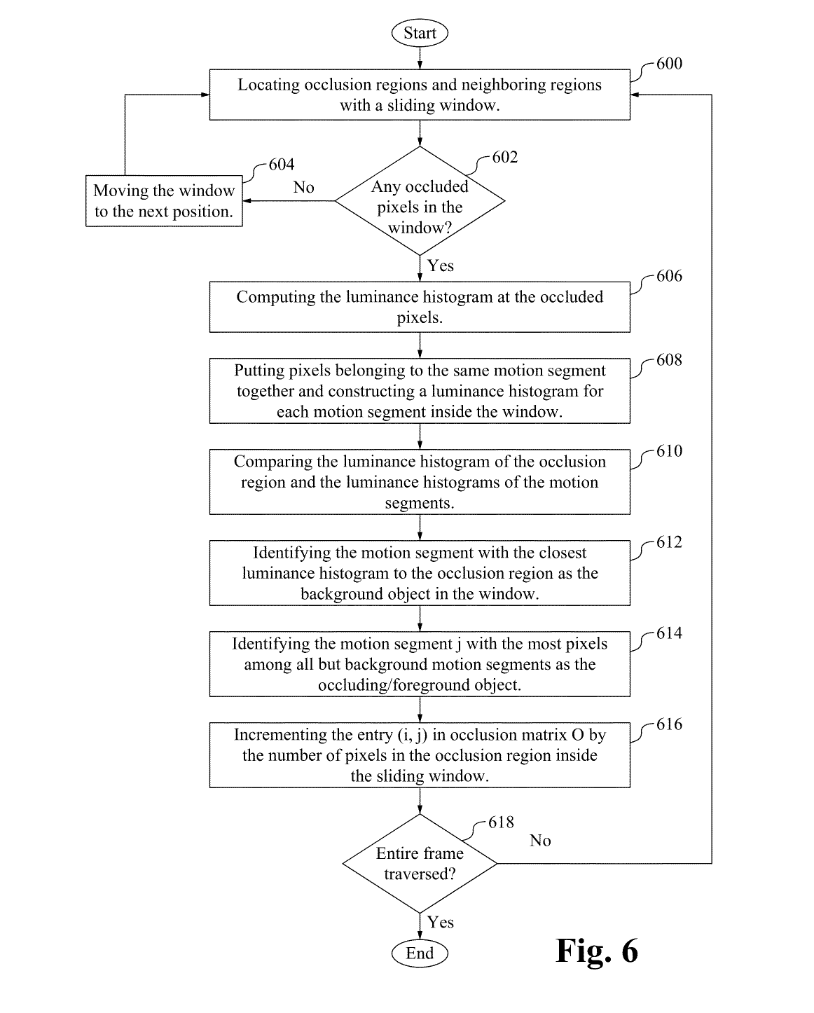

FIG. 6 illustrates a flowchart of a method of low memory usage occlusion inference according to some embodiments. In the step 600, sliding windows are used to locate occlusion regions and their neighboring regions. In the step 602, it is determined if there are any occluded pixels inside the window. If there are no occluded pixels in the window, then the window is moved to the next position in the step 604, and the process returns to the step 600. Otherwise, the luminance histogram at the occluded pixels is computed in the step 606. For other pixels inside the window, pixels belonging to the same motion segment are put together and a luminance histogram for each motion segment inside the window is constructed in the step 608. The luminance histogram of the occlusion region and the luminance histograms of the motion segments are compared in the step 610. The motion segment i with the closest luminance histogram to the occlusion region is identified as the background object in that window in the step 612. The motion segment j with the most pixels among all but background motion segments is identified as the occluding/foreground object in the step 614. Then entry (i,j) in occlusion matrix O is incremented by the number of pixels in the occlusion region inside the sliding window in the step 616. In the step 618, it is determined if the entire frame has been traversed. If the entire frame has not been traversed, the process returns to the step 600. If the entire frame has been traversed, the final occlusion matrix O is obtained to infer the occlusion relations among motion segments or objects and the process ends. In some embodiments, the order of the steps is modified. In some embodiments, more or fewer steps are implemented.

### Background Motion Estimation

Once the occlusion matrix O is obtained, the background motion can be estimated. In the depth estimation application, background motion is subtracted from motion vectors to obtain the depth map. A miscalculated background motion will produce wrong relative depth between objects, and will contradict with the occluding relations described in the occlusion matrix O. The contradiction is quantified based on occlusion matrix O. One of the motion segments is chosen as the background object. The motion in that background object will be background motion. If object k is chosen as the background object, then the depth at each object i is computed as dᵢ=∥vᵢ−vₖ∥. The contradiction from (i, j) is then

C_{k,(i,j)}=max(O_{i,j}−O_{j,i},0)I(dⱼ−dᵢ)+max(O_{j,i}−O_{i,j},0)I(dᵢ−dⱼ), (6)

where

$$I ( d ) = \{ \begin{matrix}0 & d < 0 \\ 1 & d \geq 0 ,\end{matrix}$$

and large d means close, small d means far. The contradictions when assuming vₖ as background motion are able to be computed as follows:

$${C}_{k} = {\sum }_{i = 1}^{K} {\sum }_{j = 2}^{i - 1} {C}_{k , ( i , j )} . \qquad ( 7 )$$

The background motion is assigned to be the motion that leads to the minimum amount of contradiction Cₖ. However, if the number of occluded pixels is small or the minimum contradiction is still too big, or the total number of occlusion pixels is too small to draw any statistical significance, then the largest segment is assigned to be the background object, and the corresponding motion is assigned to be the background motion.

### Application in Depth Estimation

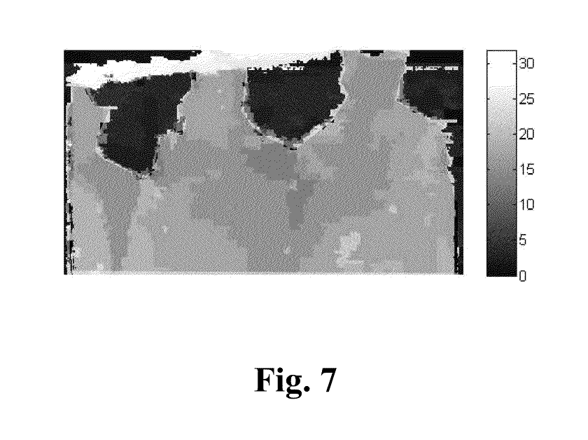

In depth estimation in monocular video sequences, motion vectors are first estimated, and then background motion is subtracted from these motion vectors to obtain the depth map. FIG. 7 shows the result of using the background motion estimation algorithm for depth estimation. The sequence is the same as FIG. 1.

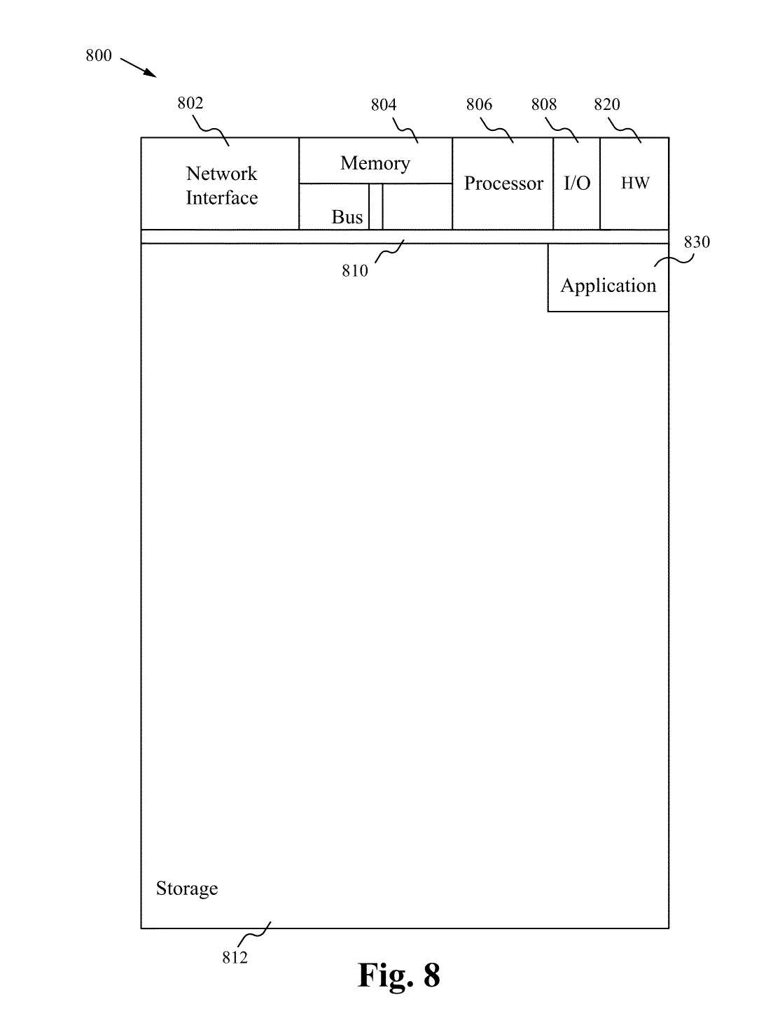

FIG. 8 illustrates a block diagram of an exemplary computing device configured to implement the occlusion-based background motion estimation method according to some embodiments. The computing device 800 is able to be used to acquire, store, compute, process, communicate and/or display information such as images and videos. In general, a hardware structure suitable for implementing the computing device 800 includes a network interface 802, a memory 804, a processor 806, I/O device(s) 808, a bus 810 and a storage device 812. The choice of processor is not critical as long as a suitable processor with sufficient speed is chosen. The memory 804 is able to be any conventional computer memory known in the art. The storage device 812 is able to include a hard drive, CDROM, CDRW, DVD, DVDRW, flash memory card or any other storage device. The computing device 800 is able to include one or more network interfaces 802. An example of a network interface includes a network card connected to an Ethernet or other type of LAN. The I/O device(s) 808 are able to include one or more of the following: keyboard, mouse, monitor, display, printer, modem, touchscreen, button interface and other devices. Occlusion-based background motion estimation application(s) 830 used to perform the occlusion-based background motion estimation method are likely to be stored in the storage device 812 and memory 804 and processed as applications are typically processed. More or less components shown in FIG. 8 are able to be included in the computing device 800. In some embodiments, occlusion-based background motion estimation hardware 820 is included. Although the computing device 800 in FIG. 8 includes applications 830 and hardware 820 for the occlusion-based background motion estimation method, the occlusion-based background motion estimation method is able to be implemented on a computing device in hardware, firmware, software or any combination thereof. For example, in some embodiments, the occlusion-based background motion estimation applications 830 are programmed in a memory and executed using a processor. In another example, in some embodiments, the occlusion-based background motion estimation hardware 820 is programmed hardware logic including gates specifically designed to implement the occlusion-based background motion estimation method.

In some embodiments, the occlusion-based background motion estimation application(s) 830 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, Blu-ray® writer/player), a television, a home entertainment system or any other suitable computing device.

To utilize the occlusion-based background motion estimation method, a user acquires a video/image such as on a digital camcorder, and before, during or after the content is acquired, the occlusion-based background motion estimation method automatically performs motion estimation on the data. The occlusion-based background motion estimation occurs automatically without user involvement.

In operation, the occlusion-based background motion estimation method is very useful in many applications, for example depth map generation, background subtraction, video surveillance and other applications. The significance of the background motion estimation method includes: 1) a motion segmentation algorithm with adaptive and temporally stable estimate of the number of objects is developed, 2) two algorithms are developed to infer occlusion relations among segmented objects using the detected occlusions and 3) background motion estimation from the inferred occlusion relations.

### Some Embodiments of Method of Occlusion-Based Background Motion Estimation

1. A method of motion estimation programmed in a memory of a device comprising:
   a. performing motion segmentation to segment an image into different objects using motion vectors to obtain a segmentation result;
   b. generating an occlusion matrix using the segmentation result, occluded pixel information and image data; and
   c. estimating background motion using the occlusion matrix.
2. The method of clause 1 wherein the occlusion matrix is of size K×K, wherein K is a number of objects in the image.
3. The method of clause 1 wherein each entry in the occlusion matrix represents the number of pixels one segment occludes another segment.
4. The method of clause 1 wherein estimating the motion of the background object includes finding the background object.
5. The method of clause 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.
6. A method of motion segmentation programmed in a memory of a device comprising:
   a. generating a histogram using input motion vectors;
   b. performing K-means clustering with a different number of clusters and generating a cost;
   c. determining a number of clusters using the cost;
   d. computing a centroid of each cluster; and
   e. clustering a motion vector at each pixel with a nearest centroid, wherein the clustered motion vector and nearest centroid segments a frame into object.
7. The method of clause 6 wherein a number of the segments is not fixed.
8. The method of clause 6 wherein a temporally stable estimation of the number of clusters is developed.
9. The method of clause 6 wherein a Bayesian approach for estimation is used.
10. The method of clause 6 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.
11. A method of occlusion relation inference programmed in a memory of a device comprising:
   a. finding a first corresponding motion segment of an occluding object;
   b. finding a pixel location in the next frame;
   c. finding a second corresponding motion segment of the occluded object;
   d. incrementing an entry in an occlusion matrix; and
   e. repeating the steps a-d until all occlusion pixels have been traversed.
12. The method of clause 11 wherein the entry represents the number of pixels a first segment occludes a second segment.
13. The method of clause 11 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.
14. A method of occlusion relation inference programmed in a memory of a device comprising:
   a. using a sliding window to locate occlusion regions and neighboring regions;
   b. moving the window if there are no occluded pixels are in the window;
   c. computing a first luminance histogram at the occluded pixels;
   d. computing a second luminance histogram for each motion segment inside the window;
   e. comparing the first luminance histogram and the second luminance histogram;
   f. identifying a first motion segment with a closest luminance histogram to an occlusion region as a background object in the window;
   g. identifying a second motion segment with the most pixels among all but background motion segments as an occluding, foreground object;
   h. incrementing an entry in an occlusion matrix by the number of pixels in the occlusion region in the window; and
   i. repeating the steps a-h until an entire frame has been traversed.
15. The method of clause 14 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.
16. A method of background motion estimation programmed in a memory of a device comprising:
   a. designing a metric to measure an amount of contradiction when selecting a motion segment as a background object;
   b. assigning a background motion to be the motion segment with a minimum amount of contradiction; and
   c. subtracting the background motion of the background object from motion vectors to obtain a depth map.
17. The method of clause 16 further comprising determining if the number of occluded pixels is below a first threshold or a minimum contradiction is above a second threshold, or determining if a total number of occlusion pixels is below a third threshold, then assigning the background object to be a largest segment, and a corresponding motion is assigned to be the background motion.
18. The method of clause 16 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.
19. An apparatus comprising:
   a. a video acquisition component for acquiring a video;
   b. a memory for storing an application, the application for:
      i. performing motion segmentation to segment an image of the video into different objects using motion vectors to obtain a segmentation result;
      ii. generating an occlusion matrix using the segmentation result, occluded pixel information and image data; and
      iii. estimating the background motion using the occlusion matrix; and
   c. a processing component coupled to the memory, the processing component configured for processing the application.
20. The apparatus of clause 19 wherein the occlusion matrix is of size K×K, wherein K is a number of objects in the image.
21. The apparatus of clause 19 wherein each entry in the occlusion matrix represents the number of pixels one segment occludes another segment.
22. The apparatus of clause 19 wherein estimating the background motion includes finding the background object.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of motion estimation programmed in a memory of a device comprising:
a. performing motion segmentation to segment an image into different objects using motion vectors to obtain a segmentation result;
b. generating an occlusion matrix using the segmentation result, occluded pixel information and image data; and
c. estimating background motion using the occlusion matrix.

2. The method of claim 1 wherein the occlusion matrix is of size K×K, wherein K is a number of objects in the image.

3. The method of claim 1 wherein each entry in the occlusion matrix represents the number of pixels one segment occludes another segment.

4. The method of claim 1 wherein estimating the motion of the background object includes finding the background object.

5. The method of claim 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.

6. A method of motion segmentation programmed in a memory of a device comprising:
a. generating a histogram using input motion vectors;
b. performing K-means clustering with a different number of clusters and generating a cost;
c. determining a number of clusters using the cost;
d. computing a centroid of each cluster; and
e. clustering a motion vector at each pixel with a nearest centroid, wherein the clustered motion vector and nearest centroid segments a frame into object.

7. The method of claim 6 wherein a number of the segments is not fixed.

8. The method of claim 6 wherein a temporally stable estimation of the number of clusters is developed.

9. The method of claim 6 wherein a Bayesian approach for estimation is used.

10. The method of claim 6 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.

11. A method of occlusion relation inference programmed in a memory of a device comprising:
a. finding a first corresponding motion segment of an occluding object;
b. finding a pixel location in the next frame;
c. finding a second corresponding motion segment of the occluded object;
d. incrementing an entry in an occlusion matrix; and
e. repeating the steps a-d until all occlusion pixels have been traversed.

12. The method of claim 11 wherein the entry represents the number of pixels a first segment occludes a second segment.

13. The method of claim 11 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.

14. A method of occlusion relation inference programmed in a memory of a device comprising:
a. using a sliding window to locate occlusion regions and neighboring regions;
b. moving the window if there are no occluded pixels are in the window;
c. computing a first luminance histogram at the occluded pixels;
d. computing a second luminance histogram for each motion segment inside the window;
e. comparing the first luminance histogram and the second luminance histogram;
f. identifying a first motion segment with a closest luminance histogram to an occlusion region as a background object in the window;
g. identifying a second motion segment with the most pixels among all but background motion segments as an occluding, foreground object;
h. incrementing an entry in an occlusion matrix by the number of pixels in the occlusion region in the window; and
i. repeating the steps a-h until an entire frame has been traversed.

15. The method of claim 14 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.

16. A method of background motion estimation programmed in a memory of a device comprising:
a. designing a metric to measure an amount of contradiction when selecting a motion segment as a background object;
b. assigning a background motion to be the motion segment with a minimum amount of contradiction; and
c. subtracting the background motion of the background object from motion vectors to obtain a depth map.

17. The method of claim 16 further comprising determining if the number of occluded pixels is below a first threshold or a minimum contradiction is above a second threshold, or determining if a total number of occlusion pixels is below a third threshold, then assigning the background object to be a largest segment, and a corresponding motion is assigned to be the background motion.

18. The method of claim 16 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.

19. An apparatus comprising:
a. a video acquisition component for acquiring a video;
b. a memory for storing an application, the application for:
i. performing motion segmentation to segment an image of the video into different objects using motion vectors to obtain a segmentation result;
ii. generating an occlusion matrix using the segmentation result, occluded pixel information and image data; and
iii. estimating the background motion using the occlusion matrix; and
c. a processing component coupled to the memory, the processing component configured for processing the application.

20. The apparatus of claim 19 wherein the occlusion matrix is of size K×K, wherein K is a number of objects in the image.

21. The apparatus of claim 19 wherein each entry in the occlusion matrix represents the number of pixels one segment occludes another segment.

22. The apparatus of claim 19 wherein estimating the background motion includes finding the background object.
